(19) United States
(12) Patent Application Publication
(10) Pub. No.: US 2007/0061196 A1
(43) Pub. Date: Mar. 15, 2007

(54) Entering advertisement creatives and buying ad space in offline properties, such as print publications for example, online

(76) Inventors: Brian Axe, San Francisco, CA (US); Steve Miller, Menlo Park, CA (US); Gokul Rajaram, Los Altos, CA (US); Susan Wojcicki, Menlo Park, CA (US)

Correspondence Address: STRAUB & POKOTYLO, 620 TINTON AVENUE, BLDG. B, 2ND FLOOR, TINTON FALLS, NJ, 07724, US

(21) Appl. No.: 11/240,793

(22) Filed: Sep. 30, 2005

Related U.S. Application Data
(60) Provisional application No. 60/716,255, filed on Sep. 12, 2005.
(60) Provisional application No. 60/718,767, filed on Sep. 20, 2005.

(51) Int. Cl. G06Q 30/00

(52) U.S. Cl. 705/14

(57) ABSTRACT

Processes for advertising on offline properties, such as print publications, may be improved by (a) accepting ad creative information and associating it with an ad identifier, (b) accepting offline property information and associating it with a property identifier, (c) determining at least one ad, each having an associated ad identifier, to be placed in or on an ad spot of an offline property, (d) generating a final ad using the ad creative information associated with the at least one ad identifier associated with the determined at least one ad, and (e) providing the final ad to an entity for placement on or in the offline property.

### § 0. PRIORITY CLAIM

Benefit is claimed, under 35 U.S.C. § 119(e)(1), to the filing date of both: (1) U.S. provisional patent application Ser. No. 60/716,255, titled “ENTERING ADVERTISMENT CREATIVES AND BUYING AD SPACE IN OFFLINE PROPERTIES, SUCH AS PRINT PUBLICATIONS FOR EXAMPLE, ONLINE”, filed on Sep. 12, 2005; and (2) U.S. provisional application Ser. No. 60/718,767, titled “PLATFORM FOR BUYING, SELLING, AND PLACING TRADITIONAL ADVERTISING SUCH AS TV, RADIO, NEWSPAPER, AND MAGAZINE, INSTEAD OF, OR IN ADDITION TO, ONLINE ADVERTISING”, filed on Sep. 20, 2005, and listing Steve Miller, Gokul Rajaram, and Nathalie Criou as inventors, for any inventions disclosed in the manner provided by 35 U.S.C. § 112, ¶1. Those provisional applications are expressly incorporated herein by reference. The scope of the present invention is not limited to any requirements of the specific embodiments described in those provisional applications.

### § 1. BACKGROUND OF THE INVENTION

§ 1.1 Field of the Invention

The present invention concerns advertising on offline properties, such a print publications for example, having spots for advertisements (referred to as “as spots”). In particular, the present invention concerns improving the means by which ads are placed on offline properties.

§ 1.2 Background Information

Traditionally, to have advertisements placed on a print publication, advertisers must (1) find a suitable publication, (2) determine available ad spots and formats for the publication, (3) make sure their ad complies with publisher guidelines, (4) agree to “terms and conditions” set forth by the publisher, (5) reserve an ad spot by a specified “reservation” date, and (6) send (or provide) a copy, sometimes a physical copy, to the publisher by a specified “material” date. The publisher might require advance payment, or might bill the advertiser later.

Some larger advertisers and larger publishers have employees or agents responsible for negotiating advertising rates, commitments, terms and employees or agents.

Unfortunately, this process is laborious for advertisers. Further, if an advertiser wants to advertise with more than one print publication, they typically need to perform this process for each publication. This may become so difficult for some advertisers, such as small advertisers, that they don't advertise at all, or limit their advertising to avoid the overhead associated with managing advertising in multiple print publications. For example, some advertisers may find it daunting to track different rates, different formats, and different terms and/or conditions, for different publishers. Some advertisers may find it challenging to send a given ad to different publishers at different locations. Some advertisers may find it challenging to find publications suitable to place their ads in.

The traditional process of placing ads in print publications also has some disadvantages for publishers. Specifically, since many advertisers may limit the publications on which they advertise, there may be less competition for ad spots on a publication. Less potential advertisers means that publishers might get less advertising revenue than they could potentially get, and might get ads that are less relevant or less useful to their readers than they could potentially get.

Thus, it would be useful to improve processes associated with advertising on print publications. It would similarly be useful to improve processes associated with adverting on other offline properties, such as billboards, posters, placard, signs, banners, sandwich boards, displays, such as those found in stations, airports, stores, other printed displays, public buses, taxis, etc.

### § 2. SUMMARY OF THE INVENTION

Embodiments consistent with the present invention may improve processes for advertising on offline properties, such as print publications, by (a) accepting ad creative information and associating it with an ad identifier, (b) accepting offline property information and associating it with a property identifier, (c) determining at least one ad, each having an associated ad identifier, to be placed in or on an ad spot of an offline property, (d) generating a final ad using the ad creative information associated with the at least one ad identifier associated with the determined at least one ad, and (e) providing the final ad to an entity for placement on or in the offline property.

### § 3. BRIEF DESCRIPTION OF THE DRAWINGS

FIG. 1 is a bubble diagram of exemplary operations that may be performed in a manner consistent with the present invention, as well as information that may be used and/or generated by such operations.

FIG. 2 is a flow diagram of an exemplary method for providing an advertiser user interface in a manner consistent with the present invention.

FIGS. 3 and 4 are flow diagrams of exemplary methods for helping advertisers to search for desired printed publications in a manner consistent with the present invention.

FIG. 5 is a flow diagram of an exemplary method for facilitating the entry of ad creative information, such as ad creative components for example, in a manner consistent with the present invention.

FIG. 6 is a flow diagram of an exemplary method for filling print publication ad spots in a manner consistent with the present invention.

FIG. 7 is an exemplary screen for allowing advertisers to search for desired printed publications in a manner consistent with the present invention.

FIG. 8 is an exemplary screen for allowing advertisers to view printed publication information and to choose to advertise in or on a printed publication in a manner consistent with the present invention.

FIG. 9 is an exemplary display screen for allowing advertisers to enter ad information, such as ad components for example, in a manner consistent with the present invention.

FIG. 10 is a block diagram of apparatus that may be used to perform at least some operations, and store at least some information, in a manner consistent with the present invention.

### § 4. DETAILED DESCRIPTION

The present invention may involve novel methods, apparatus, message formats, and/or data structures for entering advertisement creatives and buying ad space in offline properties, such as print publications for example, online. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present invention unless explicitly described as such. Also, as used herein, the article “a” is intended to include one or more items. Where only one item is intended, the term “one” or similar language is used. In the following, “information” may refer to the actual information, or a pointer to, identifier of, or location of such information. Thus, the present invention is not intended to be limited to the embodiments shown and the inventors regard their invention to include any patentable subject matter described.

In the following definitions of terms that may be used in the specification are provided in § 4.1. Then, exemplary embodiments of the present invention are described in § 4.2. Thereafter, specific examples illustrating the utility of one exemplary embodiment of the present invention are provided in § 4.3. Finally, some conclusions regarding the present invention are set forth in § 4.4.

### § 4.1 DEFINITIONS

Ads, such as those used in the exemplary embodiments described below, or any other system, may have various intrinsic features. Such features may be specified by an application and/or an advertiser. These features are referred to as “ad features” below. For example, in the case of a text ad, ad features may include a title line, ad text, etc. In the case of an image ad, ad features may include images. Depending on the type of ad, ad features may include one or more of the following: text, images, logos, a special telephone number or code to track ad “call-throughs”, a special Internet address (URL) to track user responses, etc.

When an ad is placed, one or more parameters may be used to describe how, when, and/or where the ad was placed. These parameters are referred to as “placement parameters” or “serving parameters” below. Placement parameters may include, for example, one or more of the following: features of (including information on) the property (e.g., printed publication name, issue, volume number, circulation date, etc.) on or in which, or with which, the ad was placed, an absolute position of the ad on the page on which it was placed, a position of the ad relative to other ads placed, an absolute size of the ad, a size of the ad relative to other ads, a color of the ad, a number of other ads placed, types of other ads placed, time of year placed, etc. Naturally, there are other placement parameters that may be used in the context of the invention.

Although placement parameters may be extrinsic to ad features, they may be associated with an ad as placement conditions or constraints in an automated system. When used as placement conditions or constraints, such placement parameters are referred to simply as “placement constraints” (or “targeting criteria”). For example, in some systems, an advertiser may be able to target the placement of its ad by specifying that it is only to be placed on back covers, only as a full page ad, only within an article, only in the months of November and December, etc. As another example, in some systems, an advertiser may specify that its ad is to be placed only if a page or property will include certain keywords or phrases, or includes certain topics or concepts, or falls under a particular cluster or clusters, or some other classification or classifications (e.g., verticals). As yet another example, an advertiser may specify that its ad is to be placed only on properties to be seen by a certain type of user, such as a certain demographic. Finally, in some systems an ad might be targeted so that it is placed in a property to be located in, or delivered to, a particular location.

“Ad information” may include any combination of ad features, ad placement constraints, information derivable from ad features or ad serving constraints (referred to as “ad derived information”), and/or information related to the ad (referred to as “ad related information”), as well as an extension of such information (e.g., information derived from ad related information).

A “offline property” is something on which ads can be presented. An offline property may include offline content (e.g., a newspaper, a magazine, a theatrical production, a concert, a sports event, etc.), and/or offline objects (e.g., a billboard, a stadium score board, and outfield wall, the side of truck trailer, etc.). Offline properties with content (e.g., magazines, newspapers, etc.) may be referred to as “media properties” and those printed may be referred to as “printed publications.” Although properties may themselves be offline, pertinent information about a property (e.g., attribute(s), topic(s), concept(s), category(ies), keyword(s), relevancy information, type(s) of ads supported, circulation, rates, audience demographics, location, time of publication, etc.) may be available online. For example, an outdoor jazz music festival may have entered the topics “music” and “jazz”, the location of the concerts, the time of the concerts, artists scheduled to appear at the festival, and types of available ad spots (e.g., spots in a printed program, spots on a stage, spots on seat backs, audio announcements of sponsors, etc.).

“Offline property information” may include any information included in the property, information derivable from information included in the property (referred to as “property derived information”), and/or information related to the property (referred to as “property related information”), as well as an extensions of such information (e.g., information derived from related information). An example of property derived information is a classification based on textual content of a magazine. Examples of property related information include property information from previous issues of a given printed publication.

An “offline property owner” is a person or entity that has some property right in the content of a media property. An offline property owner may be an author of the content. In addition, or alternatively, an offline property owner may have rights to reproduce the content, rights to prepare derivative works of the content, rights to display or perform the content publicly, and/or other proscribed rights in the content. A “publisher” is an example of an offline property owner.

“User information” may include user behavior information and/or user profile information.

### § 4.2 EXEMPLARY EMBODIMENTS

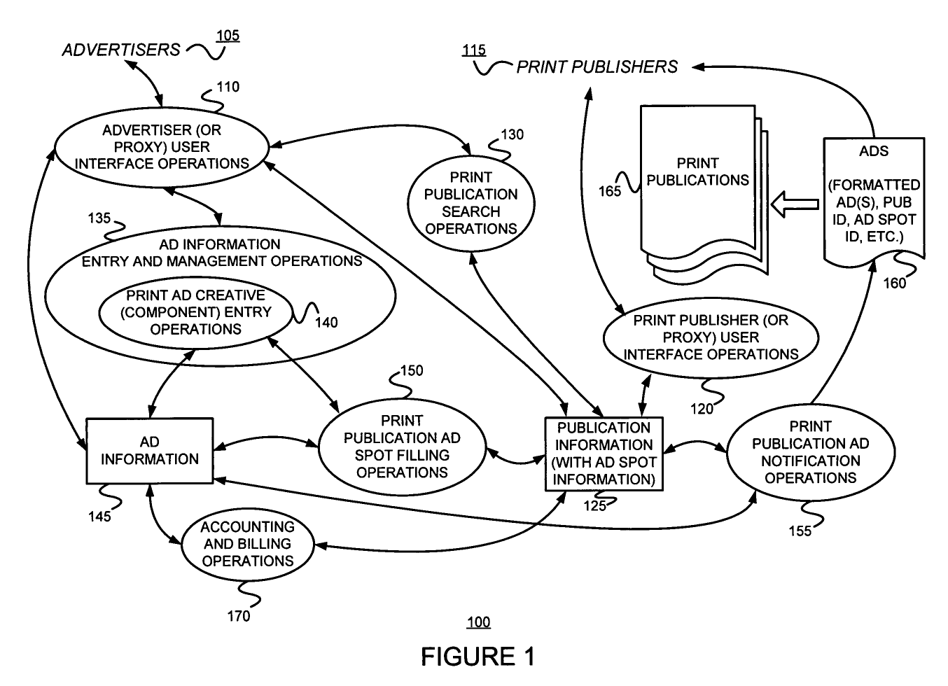

FIG. 1 is a bubble diagram of an advertising environment 100 including exemplary operations that may be performed in a manner consistent with the present invention, as well as information that may be used and/or generated by such operations. Advertisers (or a proxy) 105 may interact with the environment 100 via advertiser user interface operations 110. Print publishers (or more generally, any offline property owners) (or a proxy) 115 may interact with the environment 100 via print publisher user interface operations 120. For example, print publisher 115 many enter publication information 125 via the print publisher user interface operations 120. An advertiser 105 may search at least some of the publication information 125 via advertiser user interface operations 110 and print publication search operations 130. An advertiser 105 may also enter and manage ad information 145 via advertiser user interface operations 110 and ad information entry and management operations 135. For example, an advertiser 105 may enter ad creative information (e.g., components of an ad creative) into the ad information 145 via print ad creative (component) entry operations 140.

Print publication ad spot filling operations 150 may be used to fill available ad spots on offline properties to be published or otherwise released. Such operations 150 may work in one or more of the following ways. First, an advertiser can specify one or more printed publications in which they want their ad(s) to appear. In this scenario, it is possible to take ad spots “off the market” once they are filled by ads. It is also possible accept offers corresponding to ads, and select winning ads at a given time before publication. Second, a publisher can specify one or more ads that it wants to place in its printed publication. In this scenario, it is possible to take ads “off the market” once a budget limit (e.g., specified by an advertiser) for the ad is reached. It is also possible accept offers corresponding to ad spots, and select at a given time before publication, winning ad spots for the ad. Third, available advertisements can be automatically assigned to available ad spots in printed publications. This automated process may involve one or more of (1) finding ads that are relevant to a printed publication or ad spot thereof, (2) if there are more relevant ads than ad spots, arbitrating among competing ads, (3) finding ad spots that are relevant to an ad, and (4) if there are more relevant ad spots than can be paid for due to a budget of the ad, arbitrating among competing ad spots. Arbitration techniques and/or techniques for determining relevant ads from an online advertising environment may be used or adapted to this market for offline property ad spots. Examples of such arbitration techniques are described in U.S. Patent Application: Ser. No. 10/112,656, titled “METHODS AND APPARATUS FOR ORDERING ADVERTISEMENTS BASED ON PERFORMANCE INFORMATION”, filed on Mar. 29, 2002, and listing Georges R. Harik, Lawrence E. Page, Jane Manning and Salar Arta Kamangar as inventors; Ser. No. 10/112,654, titled “METHODS AND APPARATUS FOR ORDERING ADVERTISEMENTS BASED ON PERFORMANCE INFORMATION AND PRICE INFORMATION”, filed on Mar. 29, 2002, and listing Salar Arta Kamangar, Ross Koningstein and Eric Veach as inventors; Ser. No. 10/314,427, titled “METHODS AND APPARATUS FOR SERVING RELEVANT ADVERTISEMENTS”, filed on Dec. 6, 2002, and listing Jeffrey A. Dean, Georges R. Harik and Paul Buchheit as inventors; Ser. No. 10/375,900, titled “SERVING ADVERTISEMENTS BASED ON CONTENT”, filed on Feb. 26, 2003, and listing Darrell Anderson, Paul Buchheit, Alexander Paul Carobus, Yingwei Cui, Jeffrey A. Dean, Georges R. Harik, Deepak Jindal and Narayanan Shivakumar as inventors and Ser. No. 10/634,501, titled “SERVING CONTENT-RELEVANT ADVERTISEMENTS WITH CLIENT-SIDE DEVICE SUPPORT”, filed on Aug. 5, 2003, and listing Darrell Anderson, Paul Buchheit, Jeffrey A. Dean, Georges R. Harik, Carl Laurence Gonsalves, Noam Shazeer and Narayanan Shivakumar as inventors.

The publication information 125 may be updated to identify ads that have been determined to be placed in ad spots of upcoming print publications, and/or the ad information 145 may be updated to identify ad spots in which given ads are to be placed. In any event, print publication notification operations 155 may provide ads 160 to the print publishers so that such ads 160 may be placed in print publications 165. The ads 160 may include one or more formatted ads, a publication identifier, an ad spot identifier, etc.

Accounting and billing operations 170 may be used to assess charges to advertiser 105, and/or to track and/or make payments to print publishers 115.

4.2.1 Exemplary Methods

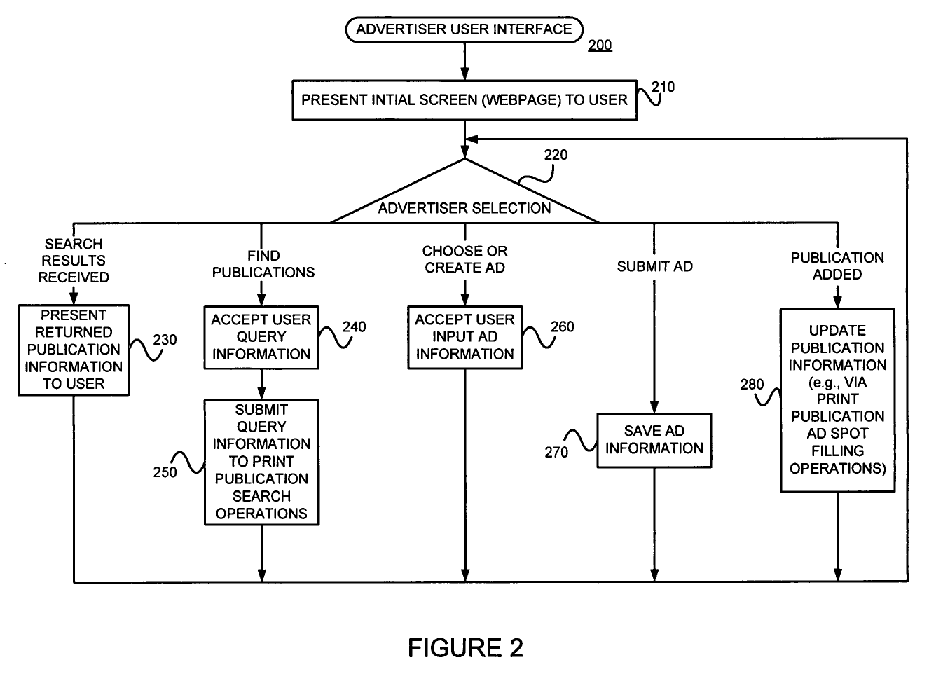

FIG. 2 is a flow diagram of an exemplary method 200 for providing an advertiser user interface in a manner consistent with the present invention. (Recall, e.g., operations 110 of FIG. 1.) An advertiser user may have been authenticated, such as via a login screen. An initial screen (e.g., a Webpage) is presented to a user. (Block 210) Various branches of the method 200 may be performed in response to the occurrence of various advertiser selections or events. If the advertiser user elects to find a publication, query information entered by the user is accepted and provided to print publication search operations. (Blocks 240 and 250) Referring back to event block 220, if search results are received, the returned publication information is presented to the user. (Block 230) Referring back to block 220, if the advertiser user elects to chose a previously created ad, or to create a new ad, ad information input by the user is accepted. (Block 260) Referring back to block 220, if the advertiser user elected to submit the ad, the ad information is saved. (Block 270) Finally, referring back to block 220, if the advertiser user elects to add a publication or ad spot (e.g., one returned and presented to the user in search results), the publication information is updated (e.g., via print publication ad spot filling operations 150). (Block 280)

Referring back to block 240, in at least some embodiments consistent with the present invention, advertisers will be allowed to search through a list of publications. Search parameters may include demographics, circulation, price, and keywords (e.g., to search over title, editorial profile, and editorial calendar (basically list of topics for each issue), content in an upcoming publication, etc.) etc.

Referring back to block 280, advertisers may select printed publications, such as magazines, they wish to purchase space in. Alternatively, or in addition, advertisers may specify particular ad spots within printed publications they wish to purchase.

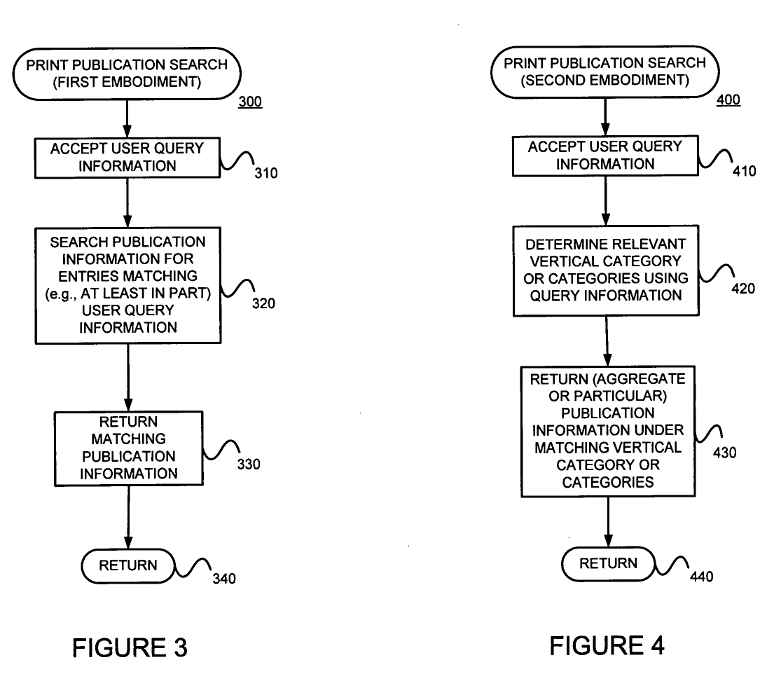

FIGS. 3 and 4 are flow diagrams of an exemplary methods 300 and 400, respectively, for helping advertisers to search for desired printed publications in a manner consistent with the present invention. Referring first to FIG. 3, user query information is accepted (Block 310), publication information is searched for entries matching (e.g., at least a part of) the user query information (Block 320), and matching publication information is returned (Block 330), before the method 300 is left (Node 340).

Now referring to FIG. 4, user query information is accepted. (Block 410) Then, at least one relevant vertical category is determined using the query information. (Block 420) A vertical category may include one or more printed publications. Thus, particular publications under the vertical category may be returned, and/or aggregated or generalized (i.e., not specific to particular printed publication(s)) information may be returned (Block 430) before the method is left (Node 440). Referring back to block 420, vertical categories may be determined using techniques described in U.S. patent application Ser. No. 11/112,732, titled “SUGGESTING TARGETING INFORMATION FOR ADS, SUCH AS WEBSITES AND/OR CATEGORIES OF WEBSITES FOR EXAMPLE”, filed on Apr. 22, 2005, and listing Sumit Agarwal, Brian Axe, David Gehrking, Ching Law, Andrew Maxwell, Gokul Rajaram and Leora Wiseman as inventors.

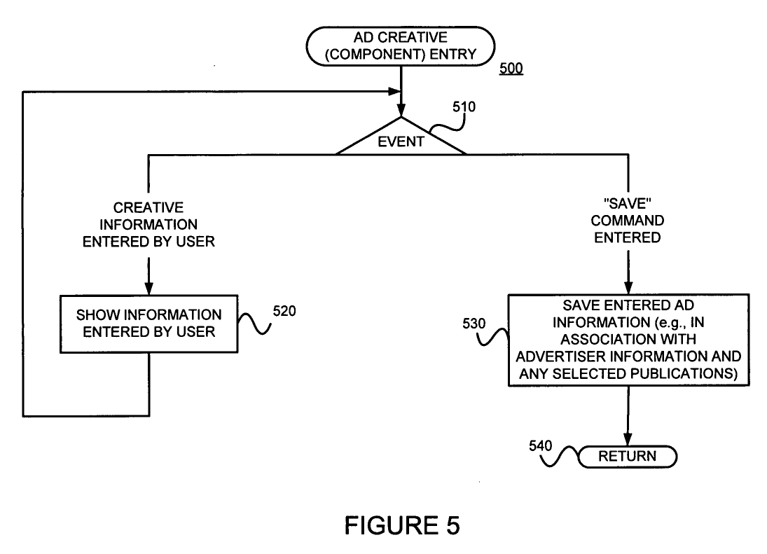

FIG. 5 is a flow diagram of an exemplary method 500 for facilitating the entry of ad creative information, such as ad creative components, in a manner consistent with the present invention. The different branches of the method 500 may be performed in response to the occurrence of different events. (Block 510) For example, if creative information is entered by the user, the information entered may be displayed back to the user (e.g., as an ad “preview”). (Block 520) Referring back to event block 510, if the user enters a “save” command, the entered ad information is saved (e.g., in association with advertiser information and any selected publications) (Block 530) before the method 500 is left (Node 540).

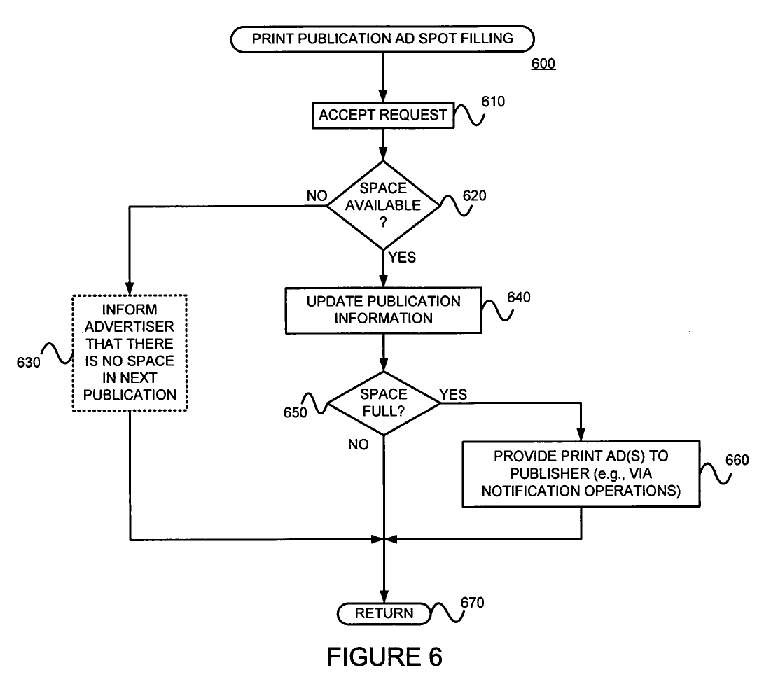

FIG. 6 is a flow diagram of an exemplary method 600 filling print publication ad spots in a manner consistent with the present invention. A request for an ad spot is accepted. (Block 610) It may be determined if space is available. (Block 620) For example, a print publication may include an available page that has room for eight ads. If there is no space available, the advertiser might be informed that there is no space in the next publication (e.g., the next issue of a magazine) (Block 630), before the method 600 is left (Node 670). Referring back to block 620, if there is space available, the publication information is updated to reflect such a selection. (Block 640) It may then be determined if the space because full (due to the placement of the ad). (Block 650) If the space becomes full, the print ad(s) may be provided to the publisher (e.g., via notification operations) (Block 660) before the method 600 is left (Node 670) If the space did not become full (more ads can be placed), the method 600 is simply left. (Node 670)

Referring back to block 610, a request for an ad spot may be generated in response to an advertiser selection, results of an automated arbitration (i.e., winning ad or ads for an ad spot), etc.

Referring back to blocks 620 and 630, in an alternative embodiment, the search operations can filter out publications that have no space available instead. In such an alternative embodiment, an advertiser will not be shown ad spots or printed publications that are already full. Alternatively, search results may inform the advertiser that a “matching” printed publication has become full.

Referring back to block 660, the print ad(s) may be provide to the publisher any time before a “material date” specified by the publisher.

4.2.2 Exemplary User Interface Screens

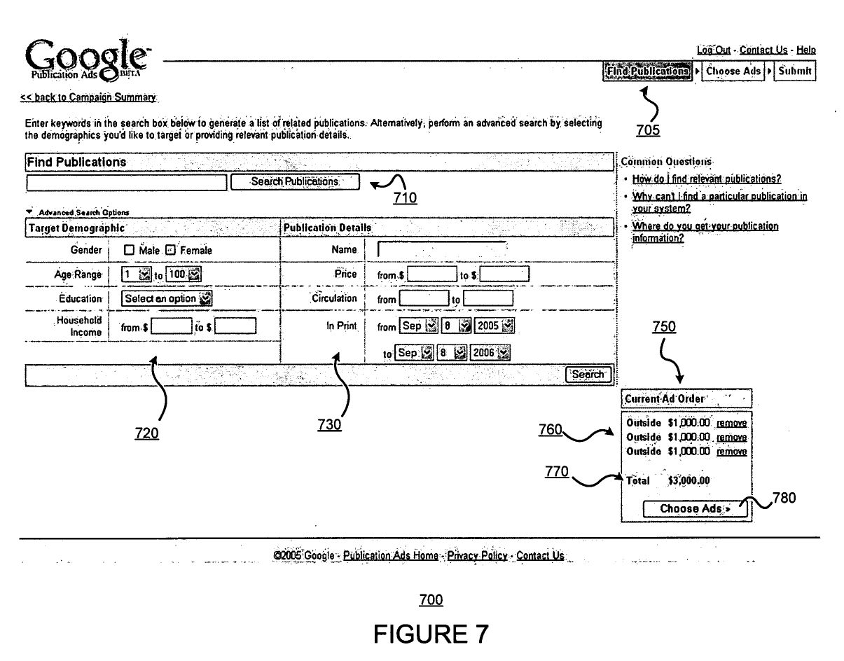

FIG. 7 is an exemplary screen 700 for allowing advertisers to search for desired printed publications in a manner consistent with the present invention. This screen 700 may be generated upon an advertiser selection of a “find publication” option. The status of the advertiser user interface is indicated by tab 705. The advertiser can search printed publications using one or more of (1) keywords 710, (2) target demographic information (e.g., reader gender, age, education, household income, etc.) 720, and (3) publication details (e.g., publication name, ad spot price (e.g., per a predetermined unit number of readers, or absolute), circulation, time in print, publication location, etc.) 730. Information block 750 may include current ad order information for the advertiser user. In this example, three, $1000.00 advertising orders have been placed in “Outside” magazine 760, for a total current spend of $3000.00 770. Given a publication, an advertiser can select ads to be placed in the publication 780.

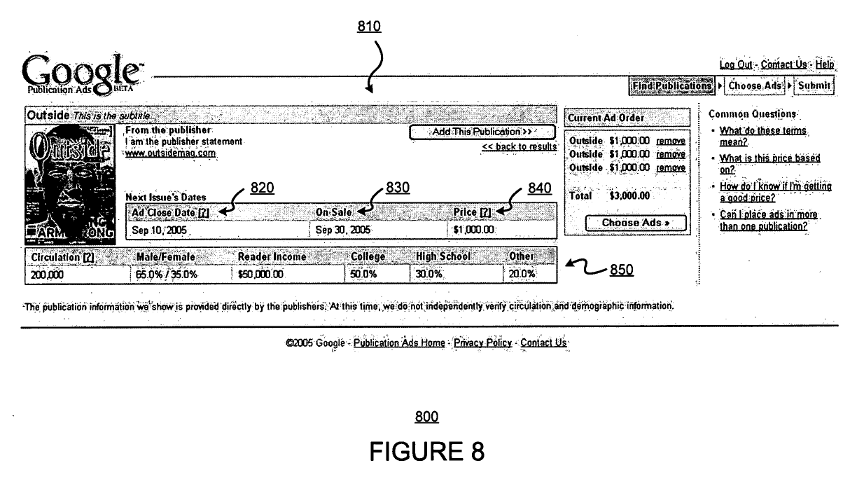

FIG. 8 is an exemplary screen 800 for allowing advertisers to view printed publication information and to choose to advertise on a printed publication in a manner consistent with the present invention. Such information may be returned in response to a search query, or may be linked from search query results. Such information may be provided in some alternative manner. In this example, the screen 800 includes one entry 810—for “Outside” magazine. Information about the next issue, such as a “close” date (sometimes referred to as a “reservation date”, this is a date after which the publisher, or the advertising network, will not accept any further ads, or after which the publisher or advertising network cannot guarantee placement of ads in the next issue) 820, an on sale date 830 for the next issue of the publication, a price to place 840 ads in the next issue, etc. Other information 850 may include circulation, and reader demographic information (e.g., gender, income, education, location, etc.). Although not shown, a “material date” (when the print publisher or ad network needs the ad) may also be provided. Other print publisher provided information, or information derived therefrom, may also be provided.

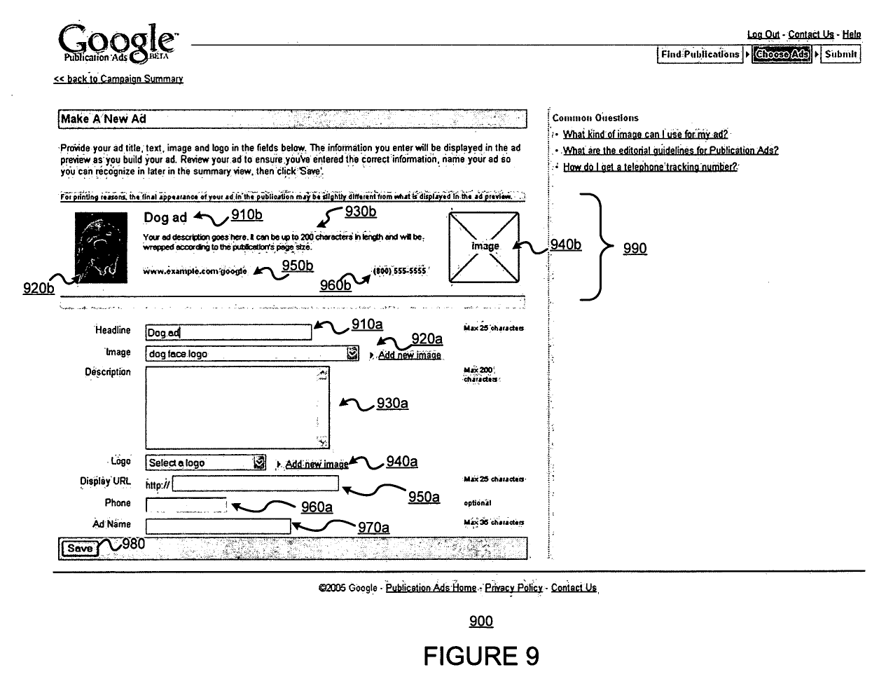

FIG. 9 is an exemplary display screen 900 for allowing advertisers to enter ad information, such as ad components, in a manner consistent with the present invention. The screen may include an ad preview section 990 for rendering the appearance of an ad, given advertiser inputs. The advertiser may input one or more of (1) an ad headline 910a (rendered as 910b in preview 990), (2) an image file 920a (rendered as 920b in preview 990), (3) descriptive text 930a (to be rendered in area 930b in preview 990), (4) a logo file 940a (to be rendered in area 940b in preview 990), (5) a display URL 950a (to be rendered in area 950b in preview 990), and (6) a telephone number 960a (to be rendered in area 960b in preview 990). The telephone number 960 and/or the URL (e.g., to a server controlled by, or for, the ad network) 970 may be used to generate sales leads, and/or to track user response. The advertiser may also enter an ad name in block 970. The ad information may be saved via save button 980.

4.2.3 Exemplary Apparatus

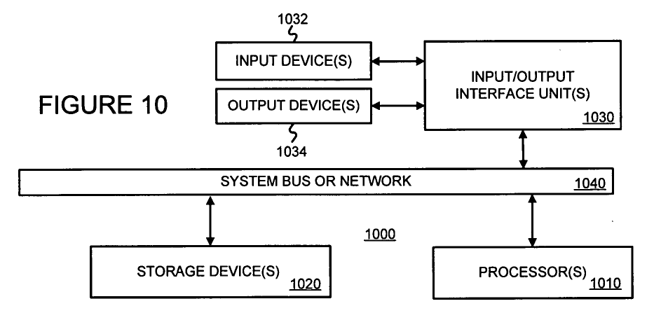

FIG. 10 is a block diagram of apparatus 1000 that may be used to perform at least some operations, and store at least some information, in a manner consistent with the present invention. The apparatus 1000 basically includes one or more processors 1010, one or more input/output interface units 1030, one or more storage devices 1020, and one or more system buses and/or networks 1040 for facilitating the communication of information among the coupled elements. One or more input devices 1032 and one or more output devices 1034 may be coupled with the one or more input/output interfaces 1030.

The one or more processors 1010 may execute machine-executable instructions (e.g., C or C++ running on the Solaris operating system available from Sun Microsystems Inc. of Palo Alto, Calif. or the Linux operating system widely available from a number of vendors such as Red Hat, Inc. of Durham, N.C.) to perform one or more aspects of the present invention. At least a portion of the machine executable instructions may be stored (temporarily or more permanently) on the one or more storage devices 1020 and/or may be received from an external source via one or more input interface units 1030.

In one embodiment, the machine 1000 may be one or more conventional personal computers. In this case, the processing units 1010 may be one or more microprocessors. The bus 1040 may include a system bus. The storage devices 1020 may include system memory, such as read only memory (ROM) and/or random access memory (RAM). The storage devices 1020 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 1032, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 1010 through an appropriate interface 1030 coupled to the system bus 1040. The output devices 1034 may include a monitor or other type of display device, which may also be connected to the system bus 1040 via an appropriate interface. In addition to (or instead of) the monitor, the personal computer may include other (peripheral) output devices (not shown), such as speakers and printers for example.

The operations described above may be performed on one or more computers. Such computers may communicate with each other via one or more networks, such as the Internet for example.

§ 4.2.4 Refinements and Alternatives

Although many of the exemplary embodiments consistent with the present invention concerned printed publications, other embodiments consistent with the present invention may be used with any offline property.

Referring back to publication information 125, such information is often included in a so-called media kit, and is referred to as “media kit information” without loss of generality. Media kit information may be manually extracted from a mailed, emailed, or uploaded media kit from the publisher. Missing information, if any, may be gathered via telephone, email, etc. Alternatively, or in addition, media kit information may be entered (e.g., in formatted fields of a template) by the publisher via a U/I.

Media kit information may include, for example, one or more of the following:
(1) “Reach Information” such as circulation numbers, pass-along audience numbers, reader (subscriber, addressee, pass-along reader, etc.) demographics.
(2) Rates (per two page spread, full page, ⅔ page, ½ page (e.g., island, horizontal, vertical, etc.), ⅓ page (e.g., square, vertical, etc.), ¼ page, other fractional page, etc.). This rate information can be normalized to a rate per formatted ad. For example, a full page rate can be converted to a rate per ad, where eight (8) ads are to be provided on a page. More than one ad format can be supported. The publisher may also specify premiums (e.g., +20% for back cover, +10% for inside back cover, +15% for inside front cover, +10% for other guaranteed positions, etc.).
(3) Issue or publication date, reservation date (i.e., date the publisher needs a commitment) and material date (i.e., date deadline that the publisher needs the actual ad(s)).
(4) Topics or themes for the issue. Feature articles. Titles. Text of upcoming articles, etc. Other information pertaining to the content of the publication.
(5) Publisher policies, such as terms and conditions.
(6) Vertical categories.
   Media kit information and publication information 125 may include more or less information.

Data related to the affects of a print ad campaign or offline ad campaign on one or more of:
(1) an online ad campaign (AdWords, AdSense, etc.);
(2) advertiser used as a search term (and perhaps volume of such searches); and
(3) advertiser appearing in content such as Webpages, blogs, etc., advertiser Website and/or landing page PageRank, etc., may be tracked.

An entity controlling a system such as that 100 of FIG. 1 may charge advertisers a flat fee, a cost (e.g., a publisher payment) plus fixed fee, a cost plus percentage fee. Thus, such an entity may engage in arbitrage, purchasing full pages on print publication and reselling, at a markup, such space to one or more advertisers. Such an entity may negotiate a flat rate per publication and may have enough purchasing power to negotiate discounts. Some or all of the savings from such discounts may be passed onto the advertisers, though such savings need not be passed onto the advertisers and may be kept by the entity.

An ad may be created first, and then a print publication(s) selected. Alternatively, or in addition, a print publication(s) may be selected first, and then an ad may be created. Alternatively, or in addition, candidate a print publication(s) may be selected and saved, the ad created, and one or more candidates selected for a given ad.

Although some of the foregoing embodiments described the filling of ad spots on a first-come, first-served basis, other techniques may be used to fill ad spots. For example, an auction at a predetermined time may arbitrate among too many ads (or too many relevant ads) competing for too few ad spots. Such embodiments may advantageously consider better offers from later committing advertisers that might have otherwise been precluded from placing their ad(s) on a (filled) ad spot.

### § 4.3 EXAMPLES OF OPERATION OF AN EXEMPLARY EMBODIMENT CONSISTENT WITH THE PRESENT INVENTION

The following example illustrates the utility of an embodiment consistent with the present invention. It is assumed that publishers have entered publication information, such as media kit information (or someone has entered such information for them).

An advertiser can create an ad by uploading/choosing images, and entering text, telephone numbers, etc., into a wizard. (Recall, e.g., screen 900 of FIG. 9.) The advertiser can then search for a print publication with desired attributes. (Recall, e.g., screen 700 of FIG. 7.) In response, the advertiser may be presented with information about a print publication(s) that matches (e.g., at least some of) the search criteria. (Recall, e.g., screen 800 of FIG. 8.)

Suppose that the advertiser places an order to have its previously created ad placed in the October 2005 issue of magazine A at a cost of $1000.00. Suppose further that the ad is to be one of six (6) ads of the same format to be placed on a single page (e.g., on the inside back cover of the next issue of magazine A). Suppose further that the ad network committed to buy, or will commit to buy, or has the option to buy the inside back cover of the next issue of magazine A.

Suppose, ultimately, the six advertisers agree to place ads on the inside back cover of the next issue of magazine A before the a specified close date. The ad network may compose a single page ad including the six ads. The ad network may format the ads to a publisher (or agreed upon) specification and aggregate the six (6) smaller ads into a full page ad. The ad network may then forward a copy of the ad (e.g., in electronic, film, or print form) to magazine A.

The ad network may assess and bill a charge of $1000.00 to each of the six (6) advertisers. The payment of the billed charges may be conditioned upon the satisfaction of one or more conditions (e.g., magazine A being published with the ad). Assume further that the ad network had negotiated a price with magazine A to place ads on the inside back cover of the next issue for $5500.00, perhaps conditioned upon the satisfaction of one or more conditions (e.g., proof of publication, such as a tear sheet). Assume that the ad network pays magazine A $5500.00 and receives six (6) payments of $1000.00 each from advertisers, thus realizing a profit of $500.00.

### § 4.4 CONCLUSIONS

Embodiments consistent with the present invention may offer one or more of the following advantages. An advertising network can gather data concerning the affects of offline advertising on other things of interest to advertisers, such as online ad campaigns, advertiser buzz (e.g., in terms of search queries, stories concerning the advertiser, etc.). An advertising network can derive profits based on the difference between its costs to get advertising spot(s) and how much it charges one or more advertisers for such ad spot(s). More and smaller advertisers can participate in the market for offline ad spots since barriers of entry are lowered. (For example, advertisers don't need to send, typically by mail or express, ad copies to multiple magazines, advertisers don't have to concern themselves with different “Terms and Conditions” (besides price) for various magazines, etc.) This increases competition and allows offline property owners to better monetize their offline properties and/or offer their readers better (e.g., more relevant ads). It also allows both advertisers and offline property owners to reduce overhead associated with placing ads on offline properties.

What is claimed is:

1. A computer-implemented method comprising:
a) accepting ad creative information and associating it with an ad identifier;
b) accepting offline property information and associating it with a property identifier;
c) determining at least one ad, each having an associated ad identifier, to be placed in or on an ad spot of an offline property;
d) generating a final ad using the ad creative information associated with the at least one ad identifier associated with the determined at least one ad; and
e) providing the final ad to an entity for placement on or in the offline property.

2. The computer-implemented method of claim 1 wherein the act of determining at least one ad to be placed in or on an ad spot of an offline property includes accepting an advertiser selection of an offline property and associating the selection with the ad identifier.

3. The computer-implemented method of claim 1 wherein the offline property is a print publication.

4. The computer-implemented method of claim 3 wherein the ad spot is selected from a group of ad spots consisting of (A) a multi-page ad spot, (B) a full page ad spot, (C) a fractional page ad spot, and (D) a printed insert.

5. The computer-implemented method of claim 1 wherein the ad spot is selected from a group of ad spots consisting of (A) a multi-page ad spot, (B) a full page ad spot, (C) a fractional page ad spot, and (D) a printed insert.

6. The computer-implemented method of claim 1 wherein the ad spot is a full page ad in a printed publication, and the final ad includes a plurality of ads.

7. The computer-implemented method of claim 6 wherein the final ad consists essentially of 6-8 ads.

8. The computer-implemented method of claim 6 wherein at least one of the plurality of ads includes a headline, descriptive text, and a visual component, the visual component including at least one of (A) an image and (B) a logo.

9. The computer-implemented method of claim 8 wherein the at least one of the plurality of ads further includes a telephone number.

10. The computer-implemented method of claim 8 wherein the at least one of the plurality of ads further includes an Internet address.

11. The computer-implemented method of claim 1 further comprising:
f) receiving a payment from advertisers associated with each of the at least one ad determined to be placed in or on an ad spot of an offline property; and
g) making a payment to an owner associated with the offline property.

12. The computer-implemented method of claim 1 further comprising:
f) confirming that the final ad was placed in or one the offline property;
g) receiving a payment from advertisers associated with each of the at least one ad determined to be placed in or on an ad spot of an offline property; and
h) making a payment to an owner associated with the offline property.

13. The computer-implemented method of claim 1 wherein the act of determining at least one ad to be placed in or on an ad spot of an offline property includes
for each ad, accepting offline property targeting information and associating it with an ad identifier,
accepting relevance information associated with an ad spot, and
determining at least one ad relevant to the ad spot using the offline property targeting information and the ad spot relevance information.

14. The computer-implemented method of claim 13 wherein if there are more relevant ads than can be accommodated by the ad spot, then arbitrating among the relevant ads to determine one or more winning ads.

15. The computer-implemented method of claim 1 wherein the offline property information includes one or more of (A) a printed publication name, (B) content of a printed publication, (C) topics of the printed publication, (D) themes of the printed publication, (E) article titles of the printed publication, (F) printed publication reader demographic information, (G) ad spot type or types, (H) ad spot price or prices, (I) time that printed publication will be in print, and (J) geographic distribution of printed publication.

16. The computer-implemented method of claim 15 further comprising:
accepting an advertiser search query,
searching the offline property information using information in the accepted advertiser search query to generate search results, and
providing the search results to the advertiser.

17. The computer-implemented method of claim 16 further comprising:
accepting an advertiser selection of at least one of the search results provided to the advertiser.

18. The computer-implemented method of claim 1 wherein the offline property information includes one or more of (A) an offline property name, (B) content of the offline property, (C) topics of the offline property, (D) themes of the offline property, (E) offline property audience demographic information, (F) ad spot type or types, (G) ad spot price or prices, (H) time that offline property will be in public, and (J) geographic location or locations of the offline property.

19. The computer-implemented method of claim 18 wherein the offline property is selected from a group of offline properties consisting of (A) a billboard, (B) signage, (C) a placard, (D) a poster, (E) a banner, and (F) a sandwich board.

20. The computer-implemented method of claim 18 further comprising:
accepting an advertiser search query,
searching the offline property information using information in the accepted advertiser search query to generate search results, and
providing the search results to the advertiser.

21. The computer-implemented method of claim 20 further comprising:
accepting an advertiser selection of at least one of the search results provided to the advertiser.

22. Apparatus comprising:
a) means for accepting ad creative information and associating it with an ad identifier;
b) means for accepting offline property information and associating it with a property identifier;
c) means for determining at least one ad, each having an associated ad identifier, to be placed in or on an ad spot of an offline property;
d) means for generating a final ad using the ad creative information associated with the at least one ad identifier associated with the determined at least one ad; and
e) means for providing the final ad to an entity for placement on or in the offline property.

23. A computer-readable medium having stored thereon computer-executable instructions which, when executed by a computer, perform the method of claim 1
